(19) United States
(12) Patent Application Publication
(10) Pub. No.: US 2006/0003225 A1
(43) Pub. Date: Jan. 5, 2006

(54) Alkaline dry battery

(76) Inventors: Takeshi Okubo, Hirakata-shi (JP); Yasuhiko Shoji, Higashiosaka-shi (JP)

Correspondence Address: McDERMOTT WILL & EMERY LLP, 600 13th Street, N.W., Washington, DC, 20005-3096, US

(21) Appl. No.: 11/170,088

(22) Filed: Jun. 30, 2005

(30) Foreign Application Priority Data
Jun. 30, 2004 (JP) 2004-194393

(51) Int. Cl. H01M 10/26; H01M 4/50

(52) U.S. Cl. 429/206; 429/224

(57) ABSTRACT

The present invention provides an alkaline dry battery excellent in constant current intermittent discharge performance. The alkaline dry battery comprises a positive electrode including manganese dioxide as a positive electrode active material; a negative electrode including zinc as a negative electrode active material; a separator disposed between the positive electrode and the negative electrode; and an electrolyte made of an alkaline aqueous solution, which is contained in the positive electrode, the negative electrode and the separator. The amount of water contained in the electrolyte is 27 to 34 parts by weight per 100 parts by weight of manganese dioxide and 72 to 80 parts by weight per 100 parts by weight of zinc. The electrolyte includes potassium hydroxide in an amount of 33 to 36 wt %.

### FIELD OF THE INVENTION

The present invention relates to an alkaline dry battery, particularly to a component thereof.

### BACKGROUND OF THE INVENTION

In order to improve discharge performance of alkaline dry batteries, various attempts have been made on the amount of positive electrode active material, that of negative electrode active material and that of electrolyte.

For example, Japanese Laid-Open Patent Publication No. Hei 8-509095 proposes that the amount of zinc serving as a negative electrode active material is not less than 2.8 g per gram of an aqueous solution of potassium hydroxide serving as an electrolyte, and that the ratio of the capacity of positive electrode to that of negative electrode is 1:1 to 1.1:1. Further, Japanese Laid-Open Patent Publication No. Hei 7-122276 proposes that the concentration of potassium hydroxide in the electrolyte is 35 to 45 wt %, and that the amount of electrolyte is 0.9 to 1.1 g per gram of zinc serving as a negative electrode active material.

With the change in usage of equipment available in the market, performance improvement in constant current intermittent discharge, a new discharge mode established by the International Electrochemical Commission (IEC), is desired. However, satisfactory discharge performance under such discharge condition has not been achieved yet.

In view of the above, in order to solve the above problem, an object of the present invention is to provide an alkaline dry battery excellent in constant current intermittent discharge performance.

### BRIEF SUMMARY OF THE INVENTION

An alkaline dry battery of the present invention comprises; a positive electrode including manganese dioxide as a positive electrode active material; a negative electrode including zinc as a negative electrode active material; a separator disposed between the positive electrode and the negative electrode; and an electrolyte comprising an alkaline aqueous solution, which is contained in the positive electrode, the negative electrode and the separator, wherein the amount of water contained in the electrolyte is 27 to 34 parts by weight per 100 parts by weight of manganese dioxide and 72 to 80 parts by weight per 100 parts by weight of zinc, and the electrolyte includes potassium hydroxide in an amount of 33 to 36 wt %.

It is preferred that the amount of water contained in said electrolyte is 28 to 32 parts by weight per 100 parts by weight of manganese dioxide and 72 to 76 parts by weight per 100 parts by weight of zinc.

According to the present invention, it is possible to provide an alkaline dry battery excellent in constant current intermittent discharge performance by appropriately adjusting the total amount of water in the battery relative to a positive electrode active material and a negative electrode active material, and the concentration of an electrolyte.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view, partly in section, of an alkaline dry battery of the present invention.

### DETAILED DESCRIPTION OF THE INVENTION

The present inventors vigorously investigated the amount of water in an alkaline dry battery relative to a positive electrode active material and to a negative electrode active material, and the concentration of an electrolyte.

As a result, they found that an alkaline dry battery with excellent constant current intermittent discharge performance can be obtained when the total amount of water contained in the battery (i.e. the total amount of water contained in a positive electrode, a negative electrode and a separator as an alkaline electrolyte) is 27 to 34 parts by weight per 100 parts by weight of manganese dioxide and 72 to 80 parts by weight per 100 parts by weight of zinc, and the electrolyte contains potassium hydroxide in an amount of 33 to 36 wt %.

By appropriately adjusting the balance between the amounts of positive and negative electrode active materials and the amount of water, water is smoothly supplied to the reaction interface between the positive and negative electrodes from the bulk of an electrolyte during rest of discharge in an intermittent discharge. This allows protons (H⁺) to diffuse into a solid phase of manganese dioxide at the positive electrode and a reaction product such as zinc hydroxide at the negative electrode to diffuse into an electrolyte. Further, since water is continuously supplied from the electrolyte even during discharge, the discharge reaction is accelerated. In other words, sufficient amount of water can be supplied from the electrolyte even during the rest of discharge and at the end of discharge.

When the amount of water is less than 27 parts by weight per 100 parts by weight of manganese dioxide, the amount of water will be insufficient, failing to provide a sufficient amount of water during the rest of discharge and at the end of discharge, resulting in decreased discharge performance. Conversely, when the amount of water exceeds 34 parts by weight per 100 parts by weight of manganese dioxide, the amount of water will be excess, reducing the amount of active material in the battery, resulting in decreased discharge performance. It is preferred that the amount of water is 28 to 32 parts by weight per 100 parts by weight of manganese dioxide.

When the amount of water is less than 72 parts by weight per 100 parts by weight of zinc, the amount of water will be insufficient, failing to provide a sufficient amount of water during the rest of discharge and at the end of discharge, resulting in decreased discharge performance. Conversely, when the amount of water exceeds 80 parts by weight per 100 parts by weight of zinc, the amount of water will be excess, reducing the amount of active material in the battery, resulting in decreased discharge performance. It is preferred that the amount of water is 72 to 76 parts by weight per 100 parts by weight of zinc.

When the concentration of potassium hydroxide in the electrolyte is less than 33 wt %, the amount of potassium which contributes to ion transfer will be extremely small, resulting in decreased discharge performance. Conversely, when the concentration of potassium hydroxide exceeds 36 wt %, the amount of water will be insufficient, failing to provide a sufficient amount of water during the rest of discharge and at the end of discharge, resulting in decreased discharge performance.

### EXAMPLE

The present invention will be described below in detail by way of examples.

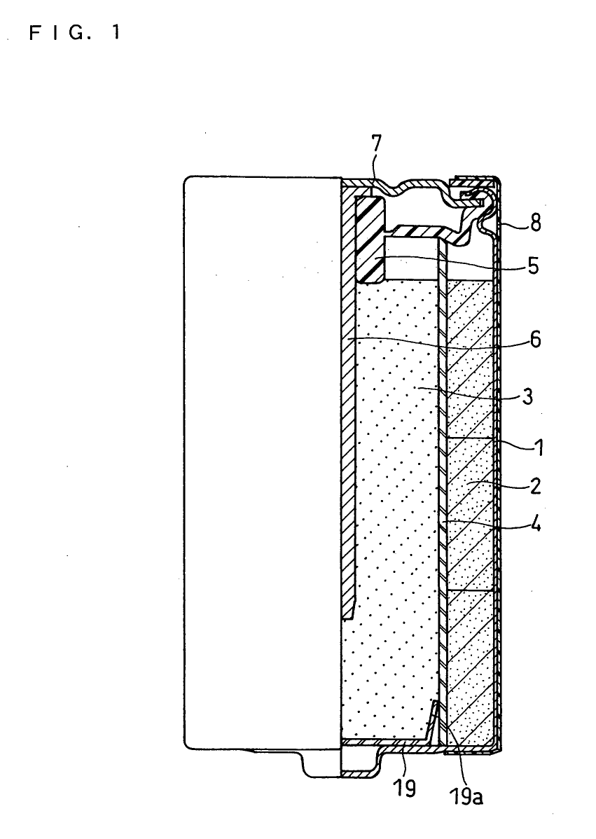

A single D-size battery (LR20) as shown in FIG. 1 was produced in the procedure below.

(1) Production of Positive Electrode Material Mixture

A mixture was prepared by mixing manganese oxide as a positive electrode active material and graphite as a conductive material at a weight ratio of 90:10. The mixture was mixed with an alkaline electrolyte at a weight ratio of 100:3, which was thoroughly stirred and molded into flakes. The positive electrode material mixture flakes were pulverized into granules, which were then classified using a sieve. The resultant with a size of 10 to 100 mesh was pressure molded into hollow cylindrical shapes to give a positive electrode material mixture 2 in the form of pellets.

(2) Assembly of Alkaline Dry Battery

Three pellets of the positive electrode material mixture 2 were inserted into a battery case 1. With the use of a pressing jig, the positive electrode material mixture 2 was remolded such that the positive electrode material mixture 2 was attached to the inner wall of the battery case 1. A separator 4 was placed such that the separator 4 was attached to the inner wall of the positive electrode material mixture 2. At the bottom of the battery case 1 was disposed a bottom paper 19. The separator 4 used here was a non-woven fabric obtained by mixing mainly polyvinyl alcohol fiber and rayon fiber.

A given amount of alkaline electrolyte was injected into the separator 4 and the bottom paper 19. After a certain length of time, a gel negative electrode 3 was then introduced into the inside of the separator 4 and the bottom paper 19. The gel negative electrode 3 used here was a mixture prepared by mixing sodium polyacrylate as a gelling agent, an alkaline electrolyte and zinc powders as a negative electrode active material at a weight ratio of 1:33:66.

A negative electrode current collector 6 was inserted in the center of the gel negative electrode 3. The negative electrode current collector 6 was integrated with a gasket 5 and a bottom plate 7 which also served as a negative electrode terminal. Finally, the opening of the battery case 1 was sealed with the bottom plate 7 with the edge of the opening of the battery case 1 crimping onto the periphery of the bottom plate 7 with the gasket 5 therebetween. The outer surface of the battery case 1 was covered with an outer label 8.

### Comparative Examples 1 to 11

Alkaline dry batteries of COMPARATIVE EXAMPLEs 1 to 11 were produced in the manner described above. As the electrolyte, an aqueous solution containing potassium hydroxide and zinc oxide was used. The weight ratio of potassium hydroxide, zinc oxide and water in the electrolyte was 38:2:60.

The amounts of the positive electrode active material, negative electrode active material, electrolyte and water were changed as shown in Table 1. In COMPARATIVE EXAMPLEs 2 to 4, the amount of the positive electrode active material was increased relative to that of COMPARATIVE EXAMPLE 1 as shown in Table 1. In COMPARATIVE EXAMPLEs 5 to 7, the amount of the negative electrode active material was increased relative to that of COMPARATIVE EXAMPLE 1 as shown in Table 1. In COMPARATIVE EXAMPLEs 8 and 9, the amount of the electrolyte was increased such that the amount of water in the battery would be the value shown in Table 1. In COMPARATIVE EXAMPLEs 10 and 11, the amount of water was increased such that the amount of water in the battery would be the values shown in Table 1. In these comparative examples, the volumes of the components in the battery were increased according to the increased amount.

TABLE 1

| | | | Amount of water in battery | |
|---|---|---|---|---|
| | | | (parts by weight) | |
| | Amount of active | | Per 100 parts by | Per 100 parts by |
| | material | | weight of positive | weight of negative |
| | Positive | Negative | electrode active | electrode active |
| | electrode | electrode | material | material |
| Comp. Ex. 1 | 100 | 100 | 25.2 | 66.1 |
| Comp. Ex. 2 | 103 | 100 | 24.6 | 66.1 |
| Comp. Ex. 3 | 105 | 100 | 24.0 | 66.1 |
| Comp. Ex. 4 | 108 | 100 | 23.4 | 66.1 |
| Comp. Ex. 5 | 100 | 107 | 25.2 | 62.0 |
| Comp. Ex. 6 | 100 | 113 | 25.2 | 58.4 |
| Comp. Ex. 7 | 100 | 120 | 25.2 | 55.2 |
| Comp. Ex. 8 | 100 | 100 | 25.9 | 68.0 |
| Comp. Ex. 9 | 100 | 100 | 26.7 | 70.0 |
| Comp. Ex. 10 | 100 | 100 | 26.0 | 68.3 |
| Comp. Ex. 11 | 100 | 100 | 26.8 | 70.4 |

### Comparative Examples 12 to 14

Alkaline dry batteries of COMPARATIVE EXAMPLEs 12 to 14 were produced in the same manner as above except that the amount of the positive electrode active material and that of the negative electrode active material were constant and only the concentration of potassium hydroxide in the electrolyte was changed to the values shown in Table 2. The concentration of zinc oxide in the electrolyte was 2 wt %.

TABLE 2

| | | | | Amount of water in battery | |
|---|---|---|---|---|---|
| | KOH | Amount of active | | (parts by weight) | |
| | concentration | material | | Per 100 parts by weight | Per 100 parts by weight |
| | in electrolyte | Positive | Negative | of positive electrode | of negative electrode |
| | (wt %) | electrode | electrode | active material | active material |
| Comp. | 30 | 100 | 100 | 28.5 | 74.9 |
| Ex. 12 | | | | | |
| Comp. | 31 | 100 | 100 | 28.1 | 73.8 |
| Ex. 13 | | | | | |
| Comp. | 32 | 100 | 100 | 27.7 | 72.7 |
| Ex. 14 | | | | | |

### Examples 1 to 8 and Comparative Examples 15 to 20

Alkaline dry batteries of EXAMPLEs 1 to 8 and COMPARATIVE EXAMPLEs 15 to 20 were produced in the same manner as above. As the electrolyte, an aqueous solution containing potassium hydroxide and zinc oxide was used. The weight ratio of potassium hydroxide, zinc oxide and water in the electrolyte was 34:2:64. That is, the concentration of potassium hydroxide was 34 wt %.

The ratio of the total amount of water in the battery to the amounts of the active materials was varied by changing the amount of the positive electrode active material and that of the negative electrode active material to the values shown in Table 3 while the volumes of the components in the battery were kept constant.

TABLE 3

| | | | Amount of water in battery | |
|---|---|---|---|---|
| | | | (parts by weight) | |
| | Amount of active | | Per 100 parts by | Per 100 parts by |
| | material | | weight of positive | weight of negative |
| | Positive | Negative | electrode active | electrode active |
| | electrode | electrode | material | material |
| Comp. Ex. 15 | 108 | 88 | 24.0 | 76.0 |
| Comp. Ex. 16 | 103 | 92 | 26.0 | 76.0 |
| Ex. 1 | 101 | 94 | 27.0 | 76.0 |
| Ex. 2 | 99 | 96 | 28.0 | 76.0 |
| Ex. 3 | 96 | 99 | 30.0 | 76.0 |
| Ex. 4 | 92 | 101 | 32.0 | 76.0 |
| Ex. 5 | 89 | 104 | 34.0 | 76.0 |
| Comp. Ex. 17 | 91 | 120 | 30.0 | 60.0 |
| Comp. Ex. 18 | 92 | 113 | 30.0 | 64.0 |
| Comp. Ex. 19 | 94 | 108 | 30.0 | 68.0 |
| Ex. 6 | 95 | 103 | 30.0 | 72.0 |
| Ex. 7 | 96 | 99 | 30.0 | 76.0 |
| Ex. 8 | 97 | 95 | 30.0 | 80.0 |
| Comp. Ex. 20 | 97 | 91 | 30.0 | 84.0 |

### Examples 9 to 12 and Comparative Examples 21 to 22

Alkaline dry batteries of EXAMPLEs 9 to 12 and COMPARATIVE EXAMPLEs 21 to 22 were produced in the same manner as above except that the concentration of potassium hydroxide in the electrolyte was changed to the values shown in Table 4. The concentration of zinc oxide in the electrolyte was 2 wt %.

The ratio of the total amount of water in the battery to the amounts of the active materials was varied by changing the amount of the positive electrode active material and that of the negative electrode active material to the values shown in Table 4 while the volumes of the components in the battery were kept constant.

TABLE 4

| | | | | Amount of water in battery | |
|---|---|---|---|---|---|
| | KOH | Amount of active | | (parts by weight) | |
| | concentration in | material | | Per 100 parts by weight | Per 100 parts by weight |
| | electrolyte | Positive | Negative | of positive electrode | of negative electrode |
| | (wt %) | electrode | electrode | active material | active material |
| Comp. | 32 | 102 | 105 | 30.0 | 76.0 |
| Ex. 21 | | | | | |
| Ex. 9 | 33 | 99 | 102 | 30.0 | 76.0 |
| Ex. 10 | 34 | 96 | 99 | 30.0 | 76.0 |
| Ex. 11 | 35 | 93 | 96 | 30.0 | 76.0 |
| Ex. 12 | 36 | 90 | 93 | 30.0 | 76.0 |
| Comp. | 37 | 87 | 90 | 30.0 | 76.0 |
| Ex. 22 | | | | | |

Note that, in Tables 1 to 4, the amount of the positive electrode active material and that of the negative electrode active material are shown in relative values with those of COMPARATIVE EXAMPLE 1 (i.e. conventional conditions) set to 100.

The alkaline dry batteries of EXAMPLEs 1 to 12 and COMPARATIVE EXAMPLEs 1 to 22 were subjected to the following evaluation tests.

[Evaluation]

(i) Constant Current Intermittent Discharge Test

The alkaline dry batteries of EXAMPLEs 1 to 12 and COMPARATIVE EXAMPLEs 1 to 22, three of each, were continuously discharged at a current of 600 mA per day to a voltage of 0.9 V in an ambient temperature of 20° C. for two hours, during which discharge time was measured. Then, the average discharge time for three batteries was determined.

(ii) Overdischarge Test

Using each of the alkaline dry batteries of EXAMPLEs 1 to 12 and COMPARATIVE EXAMPLEs 1 to 22, five sets, each set including four batteries connected in series with a resistance of 40 ohms, were prepared and then allowed to stand at room temperature for 6 weeks, after which the number of batteries with electrolyte leakage was counted.

The results obtained from the above tests were shown in Tables 5 to 8. Note that discharge performance index in Tables 5 to 8 was shown in relative values with the discharge time of COMPARATIVE EXAMPLE 1 set to 100. When the discharge performance index was not less than 110, the battery was evaluated to have a good discharge performance.

TABLE 5

| | | Percentage of |
|---|---|---|
| | Discharge performance | batteries with |
| | index | electrolyte leakage(%) |
| Comp. Ex. 1 | 100 | 0 |
| Comp. Ex. 2 | 100 | 0 |
| Comp. Ex. 3 | 101 | 0 |
| Comp. Ex. 4 | 102 | 20 |
| Comp. Ex. 5 | 101 | 0 |
| Comp. Ex. 6 | 103 | 40 |
| Comp. Ex. 7 | 105 | 80 |
| Comp. Ex. 8 | 103 | 0 |
| Comp. Ex. 9 | 107 | 20 |
| Comp. Ex. 10 | 104 | 0 |
| Comp. Ex. 11 | 108 | 20 |

TABLE 6

| | | Percentage of |
|---|---|---|
| | Discharge performance | batteries with |
| | index | electrolyte leakage(%) |
| Comp. Ex. 12 | 100 | 0 |
| Comp. Ex. 13 | 101 | 0 |
| Comp. Ex. 14 | 103 | 0 |

TABLE 7

| | | Percentage of |
|---|---|---|
| | | batteries with |
| | Discharge performance | electrolyte leakage(%) |
| | index | (%) |
| Comp. Ex. 15 | 106 | 0 |
| Comp. Ex. 16 | 109.6 | 0 |
| Ex. 1 | 111 | 0 |
| Ex. 2 | 113 | 0 |
| Ex. 3 | 118 | 0 |
| Ex. 4 | 114 | 0 |
| Ex. 5 | 110 | 0 |
| Comp. Ex. 17 | 105 | 0 |
| Comp. Ex. 18 | 106 | 0 |
| Comp. Ex. 19 | 108 | 0 |
| Ex. 6 | 113 | 0 |
| Ex. 7 | 118 | 0 |
| Ex. 8 | 110.2 | 0 |
| Comp. Ex. 20 | 106 | 0 |

TABLE 8

| | | Percentage of |
|---|---|---|
| | Discharge performance | batteries with |
| | index | electrolyte leakage(%) |
| Comp. Ex. 21 | 109 | 0 |
| Ex. 9 | 114 | 0 |
| Ex. 10 | 118 | 0 |
| Ex. 11 | 116 | 0 |
| Ex. 12 | 113 | 0 |
| Comp. Ex. 22 | 108 | 0 |

As shown in Table 5, in the alkaline dry batteries of COMPARATIVE EXAMPLEs 1 to 11, although the discharge performance was improved due to the increase of the amount of active material or the amount of electrolyte, the overdischarge characteristics were decreased. This is because the space inside the battery was reduced due to the increase of the volumes of the components in the battery, and leakage of electrolyte was observed. Likewise, as shown in Table 6, in the alkaline dry batteries of COMPARATIVE EXAMPLEs 12 to 14 in which the concentration of potassium hydroxide in the electrolyte was decreased, the amount of water in the battery per 100 parts by weight of the positive electrode active material was 27 to 34 parts by weight, and the amount of water in the battery per 100 parts by weight of the negative electrode active material was 72 to 80, any significant improvement in discharge performance was not observed.

As shown in Tables 7 and 8, in the alkaline dry batteries of EXAMPLEs 1 to 12 in which the amount of water in the battery per 100 parts by weight of the positive electrode active material was 27 to 34 parts by weight, the amount of water in the battery per 100 parts by weight of the negative electrode active material was 72 to 80 parts by weight, and the concentration of potassium hydroxide in the electrolyte was 33 to 36 wt %, discharge performance index was significantly improved compared to the alkaline dry batteries of COMPRATIVE EXAMPLEs 15 to 22, and electrolyte leakage during overdischarge was not observed in any of the batteries.

The alkaline dry battery of the present invention is applicable as a power source for high-performance small electronic devices and portable devices.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline dry battery comprising:
a positive electrode including manganese dioxide as a positive electrode active material;
a negative electrode including zinc as a negative electrode active material;
a separator disposed between said positive electrode and said negative electrode; and
an electrolyte comprising an alkaline aqueous solution, which is contained in said positive electrode, said negative electrode and said separator,
wherein the amount of water contained in said electrolyte is 27 to 34 parts by weight per 100 parts by weight of manganese dioxide and 72 to 80 parts by weight per 100 parts by weight of zinc, and
said electrolyte includes potassium hydroxide in an amount of 33 to 36 wt %.

2. The alkaline dry battery in accordance with claim 1, wherein the amount of water contained in said electrolyte is 28 to 32 parts by weight per 100 parts by weight of manganese dioxide and 72 to 76 parts by weight per 100 parts by weight of zinc.
